(19) United States
(12) Patent Application Publication
(10) Pub. No.: US 2025/0141805 A1
(43) Pub. Date: May 1, 2025

(54) ELECTRONIC DEVICE FOR DISTRIBUTED SCHEDULING IN NETWORK AND METHOD OF OPERATING THE SAME

(71) Applicant: Electronics and Telecommunications Research Institute, Daejeon (KR)

(72) Inventors: Hyun Kyung YOO, Daejeon (KR); SUNG HYUK BYUN, Daejeon (KR); Namseok KO, Daejeon (KR)

(21) Appl. No.: 18/815,758

(22) Filed: Aug. 26, 2024

(30) Foreign Application Priority Data
Oct. 31, 2023 (KR) 10-2023-0147850
Jan. 31, 2024 (KR) 10-2024-0015115

(51) Int. Cl. H04L 47/12; H04L 47/10

(52) U.S. Cl. CPC H04L 47/12; H04L 47/29

(57) ABSTRACT

An electronic device for distributed scheduling of a network and a method of operating the same are provided. The electronic device includes a processor and a memory configured to store instructions, wherein the instructions, when executed by the processor, may cause the electronic device to determine a traffic demand for a network connection, based on the traffic demand, determine a burst level for traffic of a predetermined time period and transmit the burst level to a control device, by comparing the burst level with a threshold value determined by the control device, determine whether the traffic demand is in a traffic over-demand state, receive a token for connecting to a circuit switch to distribute the traffic demand, and when the traffic demand is in the traffic over-demand state, connect to the circuit switch through the token.

### CROSS-REFERENCE TO RELATED APPLICATION

This application claims the benefit of Korean Patent Application No. 10-2023-0147850, filed on Oct. 31, 2023, and Korean Patent Application No. 10-2024-0015115, filed on Jan. 31, 2024, in the Korean Intellectual Property Office, the entire disclosures of which are incorporated herein by reference for all purposes.

### BACKGROUND

### 1. Field of the Invention

One or more embodiments relate to an electronic device for distributed scheduling of a network and a method of operating the same.

### 2. Description of the Related Art

Atop of rack (ToR) switch may refer to a switch installed at the top of a rack to manage connections with servers, etc., in a network structure used in a data center. Research on a network scheduling technique is being conducted to manage network resources and traffic used by the ToR switch. A reconfigurable data center network (RDCN) may represent a network structure to solve situations in which excessive demands are placed on specific ToR switches in a data center network. An RDCN structure may be designed to use circuit switches that may provide greater bandwidth, without connections through a packet network.

Dynamic scheduling, one of the RDCN scheduling methods, may perform optimized scheduling by obtaining traffic demand information for the total ToR switches from a centralized network controller. In the dynamic scheduling method, all processes required for reconfiguration are performed in the network controller, and therefore it may take a long time to obtain the traffic demand information and calculate an optimal schedule based on the obtained traffic demand information. As another RDCN scheduling method, a fixed scheduling method may perform repetitive round robin (RR)-based connections for connections between all ToR switches. Since the fixed scheduling method does not consider traffic characteristics, a time burden required to predict traffic demands or calculate scheduling may be reduced, but unnecessary waste of circuit switch resources may occur.

### SUMMARY

Embodiments may provide a distributed reconfigurable data center network (RDCN) scheduling method of considering traffic demands and avoiding intervention by a centralized network controller.

Embodiments may provide a scheduling method of allocating circuit switch resources to avoid duplication when using a distributed scheduling method.

Embodiments may determine whether a traffic demand is in a traffic over-demand state and may provide a method of efficiently connecting to a circuit switch through a token.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided an electronic device including a processor and a memory configured to store instructions, wherein the instructions, when executed by the processor, may cause the electronic device to determine a traffic demand for a network connection, based on the traffic demand, determine a burst level for traffic of a predetermined time period and transmit the burst level to a control device, by comparing the burst level with a threshold value determined by the control device, determine whether the traffic demand is in a traffic over-demand state, receive a token for connecting to a circuit switch to distribute the traffic demand, and when the traffic demand is in the traffic over-demand state, connect to the circuit switch through the token.

The instructions, when executed by the processor, may cause the electronic device to, when the traffic demand is not in the traffic over-demand state or when the connection of the circuit switch is terminated, transmit the token to a next electronic device in a predetermined order.

The instructions, when executed by the processor, may cause the electronic device to determine a time to connect to the circuit switch, based on the burst level, and connect to the circuit switch during the time.

The threshold value may be determined based on a burst level of each electronic device connected to the control device.

The threshold value may be determined as one burst level among burst levels of electronic devices connected to the control device.

The token may be transmitted in a predetermined order between electronic devices connected to the control device.

The instructions, when executed by the processor, may cause the electronic device to determine the traffic demand using count-min sketch (CMS).

The electronic device may be a switch used in top of rack (ToR).

According to another aspect, there is provided a control device including a processor and a memory configured to store instructions, wherein the instructions, when executed by the processor, may cause the control device to obtain a burst level for traffic of a predetermined time period of connected electronic devices, based on the burst level, determine a threshold value to determine a traffic over-demand, and transmit the threshold value to each electronic device.

The electronic device may be configured to, by comparing the burst level with the threshold value, determine whether a traffic demand of the electronic device is in a traffic over-demand state.

The instructions, when executed by the processor, may cause the electronic device to determine one burst level among burst levels of the connected electronic devices as the threshold value.

According to another aspect, there is provided a method of operating an electronic device, the method including determining a traffic demand for a network connection, based on the traffic demand, determining a burst level for traffic of a predetermined time period and transmitting the burst level to a control device, by comparing the burst level with a threshold value determined by the control device, determining whether the traffic demand is in a traffic over-demand state, receiving a token for connecting to a circuit switch to distribute the traffic demand, and when the traffic demand is in the traffic over-demand state, connecting to the circuit switch through the token.

The method may further include, when the traffic demand is not in the traffic over-demand state or when the connection of the circuit switch is terminated, transmitting the token to a next electronic device in a predetermined order.

The connecting to the circuit switch may include determining a time to connect to the circuit switch, based on the burst level and connecting to the circuit switch during the time.

The threshold value may be determined based on a burst level of each electronic device connected to the control device.

The threshold value may be determined as one burst level among burst levels of electronic devices connected to the control device.

The token may be transmitted in a predetermined order between electronic devices connected to the control device.

The determining of the traffic demand may include determining the traffic demand using CMS.

Additional aspects of embodiments will be set forth in part in the description which follows and, in part, will be apparent from the description, or may be learned by practice of the disclosure.

According to embodiments, a distributed RDCN scheduling method may be provided, and thus, a load on a centralized network controller may be reduced and network throughput may be efficiently increased.

According to embodiments, a traffic demand of an electronic device may be independently determined and whether the traffic demand is in a traffic over-demand state may be determined to optimize a circuit switch path, thereby improving efficiency and stability of the total network.

According to embodiments, circuit switches may be prevented from being allocated redundantly, thereby increasing resource utilization, maintaining network stability, and improving overall performance of a data center network.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a structure and operation of distributed scheduling of a network by an electronic device and a control device, according to an embodiment;

FIG. 2 is a diagram illustrating network throughput of distributed scheduling by an electronic device and a control device, according to an embodiment;

FIG. 3 is a schematic flowchart of an electronic device for distributed scheduling of a network, according to an embodiment;

FIG. 4 is a schematic flowchart of a control device for distributed scheduling of a network, according to an embodiment;

FIG. 5 is a schematic block diagram of an electronic device for distributed scheduling of a network, according to an embodiment; and

FIG. 6 is a schematic block diagram of a control device for distributed scheduling of a network, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

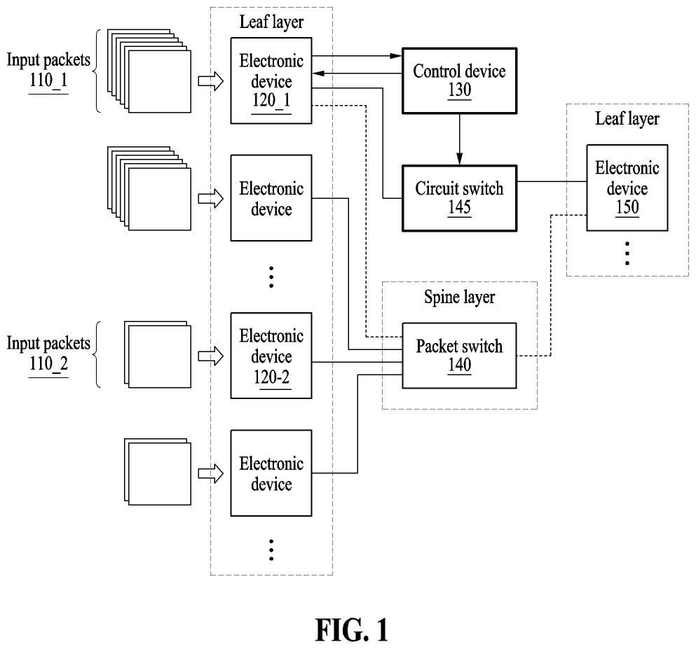

FIG. 1 is a diagram illustrating a structure and operation of distributed scheduling of a network by an electronic device and a control device, according to an embodiment.

Referring to FIG. 1, a structure of input packets 110_1 and 110_2, electronic devices 120_1, 120_2, and 150, a control device 130, a packet switch 140, and a circuit switch 145 for configuring a reconfigurable data center network (RDCN) is shown as an example.

A spine-leaf architecture may represent a data center network topology including two types of switching layers, which are a spine layer and a leaf layer. The leaf layer may aggregate traffic generated by a server and may include an access switch for connecting to the spine layer or a network core. A switch in the spine layer may connect leaf switches in the topology to each other.

The input packets 110_1 and 110_2 may represent one or more packets that are input to a server rack including the electronic devices 120_1 and 120_2. According to an embodiment, the input packets 110_1 and 1102 may be divided into the input packet 110_1 with elephant flow having high traffic and the input packet 110_2 with mice flow having low traffic, depending on the amount of data.

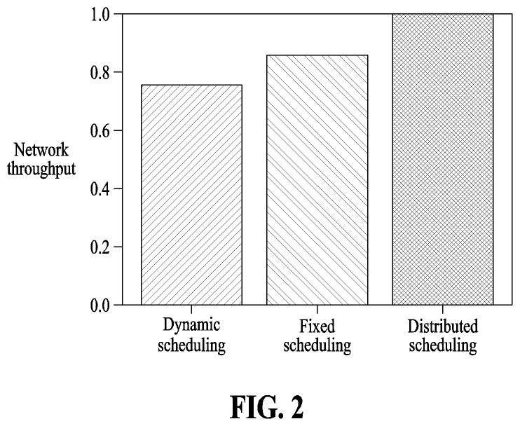

The electronic devices 120_1 and 120_2 may represent switches for network connection in the leaf layer. According to an embodiment, the electronic devices 120_1 and 120_2 may represent switches used for top of rack (ToR), that is, ToR switches. In FIG. 2, only four electronic devices in one leaf layer are shown for description, but the embodiments are not limited thereto. The number of electronic devices for a network configuration may be one or more.

The electronic devices 120_1 and 1202 may determine a traffic demand for the input packets 110_1 and 110_2 that are input to the server rack in the leaf layer. According to an embodiment, the electronic devices 120_1 and 120_2 may determine the traffic demand based on count-min sketch (CMS). The CMS may represent a data structure for predicting the traffic demand by determining how much traffic comes in for each flow. The CMS may be implemented using a programmable data plane. The CMS may provide information to request path allocation to the circuit switch 145 based on distributed traffic demand prediction.

The electronic devices 120_1 and 1202 may determine a burst level for traffic, based on the determined traffic demand. The burst level may represent the extent to which traffic increases rapidly due to a large amount of data being transmitted during a predetermined time period. In addition, according to an embodiment, the electronic devices 120_1 and 120_2 may determine the time to maintain connection with the circuit switch 145 to distribute the traffic demand, based on the burst level.

The control device 130 may be a controller of a software-defined network and may allocate circuit switch resources in response to an allocation request from the electronic devices 120_1 and 120_2. The control device 130 may include an open network operating system (ONOS).

The control device 130 may convert a connection path between electronic devices in different leaf layers from the existing packet switch 140 into the circuit switch 145. For example, when the burst level of the electronic device 120_1 is high, the control device 130 may convert a network connection path between the electronic device 120_1 and the electronic device 150 from the existing packet switch 140 into the circuit switch 145. The electronic device 120_1 may be connected to the electronic device 150 by connecting to the circuit switch 145.

The packet switch 140 may divide the input packets 1101 into packets and may transmit the input packets 110_1 to a destination. The circuit switch 145 may set a communication path and may transmit the input packets 110_1 to a destination, with a fixed bandwidth. Since the circuit switch 145 does not have a buffer, when the circuit switch 145 is allocated redundantly by the control device 130, it may be difficult to recover loss due to a collision.

A distributed resource management algorithm performed by the electronic devices 120_1 and 120_2 may use a token to avoid redundant allocation of the circuit switch 145 during distributed scheduling. The distributed resource management algorithm may use a token ring network.

In the distributed resource management algorithm, the token may be repeatedly transmitted in a predetermined order between electronic devices connected to the control device 130. The electronic device 120_1 having the token may have the right to use the circuit switch 145.

The electronic device 120_1 may determine whether to connect to the circuit switch 145, based on the determined traffic demand. In other words, the electronic device 120_1 may determine whether the traffic demand of the electronic device 120_1 is in a traffic over-demand state. When the traffic demand is in the traffic over-demand state, the electronic device 120_1 may wait for the turn to receive the token and after receiving the token, may change a port to connect to the circuit switch 145.

The electronic device 120_1 may compare a threshold value determined by the control device 130 to the burst level of the electronic device 120_1 and may determine whether the traffic demand is in the traffic over-demand state. The threshold value may be determined based on the burst level of each electronic device connected to the control device 130. The control device 130 may obtain the burst level of all electronic devices periodically connected at predetermined intervals. According to an embodiment, the control device 130 may determine the threshold value as one burst level among the burst levels of connected electronic devices. For example, the control device 130 may determine an upper 10 percent (%) value of the obtained burst level as the threshold value. The control device 130 may transmit the determined threshold value to the entire electronic device 120_1. The electronic device 120_1 that has received the threshold value may compare the threshold value with the burst level of the electronic device 120_1 to determine whether the traffic demand is in the traffic over-demand state. Thereafter, when the electronic device 120_1 in the traffic over-demand state receives the token, the electronic device 1201 may connect to the circuit switch 145 through the token.

When the electronic device 120_1 completes the connection with the circuit switch 145, the electronic device 120_1 may transmit the token to a next electronic device in a predetermined order. In addition, when the electronic device 120_1 receives the token, the electronic device 120_1 may transmit the token to the next electronic device even if there is no need to use the circuit switch 145. In other words, when the traffic demand of the electronic device 120_1 is not in the traffic over-demand state, the electronic device 1201 may transmit the token to the next electronic device.

The above-described distributed resource management algorithm using a dynamic threshold value may induce better local selection by considering the entire system and a switch having a higher burst level may use the token preferentially, thereby increasing throughput in a network system.

For example, an operation of the electronic device 120_1 in the above-described process may be expressed by the algorithm below.

Algorithm 1 P4-ToRs Distributed Scheduling Algorithm

| | |
|---|---|
| 1: | Init Threshold = 0 |
| 2: | Init BurstLevel = 0 |
| 3: | Init UsingCircuit = False |
| 4: | Init HaveToken = False |
| 5: | while True do |
| 6: | BurstLevel = MeasureBurst( ) |
| 7: | if TokenReceived( ) then |
| 8: | HaveToken = True |
| 9: | end if |
| 10: | SendBurstToCtrl( ) |
| 11: | if BurstLevel >Threshold and HaveToken then |
| 12: | ReqCircuit( ) |
| 13: | SwitchPortToCircuit( ) |
| 14: | UsingCircuit = True |
| 15: | Duration = CalcDuration(BurstLevel) |
| 16: | end if |
| 17: | if UsingCircuit then |
| 18: | Duration −= 1 |
| 19: | if Duration <= 0 then |
| 20: | SwitchPortToPacket( ) |
| 21: | UsingCircuit = False |
| 22: | PassToken( ) |
| 23: | HaveToken = False |
| 24: | end if |
| 25: | end if |
| 26: | end while |

For example, an operation of the control device 130 in the above-described process may be expressed by the algorithm below.

Algorithm 2 Controller Algorithm

| | |
|---|---|
| 1: | Init ListOfToRsBurstLevels = [ ] |
| 2: | while True do |
| 3: | ListOfToRsBurstLevels = RecvBurstLevels( ) |
| 4: | Threshold = CalcTop20%(ListOfToRsBurstLevels) |
| 5: | BroadcastThreshold(Threshold) |
| 6: | if ReqCircuitReceived( ) then |
| 7: | AllocateCircuit( ) |
| 8: | end if |
| 9: | end while |

FIG. 2 is a diagram illustrating network throughput of distributed scheduling by an electronic device and a control device, according to an embodiment.

Referring to FIG. 2, a graph comparing network throughput of dynamic scheduling, fixed scheduling, and distributed scheduling according to an embodiment is shown as an example.

The graph in FIG. 2 may evaluate performance of scheduling based on network throughput aggregated over a predetermined period of time and may represent relative throughput compared to dynamic scheduling for a same traffic condition used for measurement.

The dynamic scheduling may collect, from a network control device, the amount of traffic stacked up in a queue of an electronic device and may determine which electronic devices to connect to a circuit switch.

The fixed scheduling may perform round robin (RR)-based repetitive scheduling for connections between all electronic devices.

As shown in FIG. 2, the fixed scheduling may perform improved network throughput by about 13.81% compared to the dynamic scheduling, and the distributed scheduling according to an embodiment may perform improved network throughput by about 15.48% compared to the fixed scheduling. The distributed scheduling according to an embodiment may perform scheduling of circuit switch resources through distributed traffic demand prediction and may eliminate the possibility of circuit switch collision due to application of the distributed scheduling through application of a distributed resource management algorithm, thereby improving network throughput.

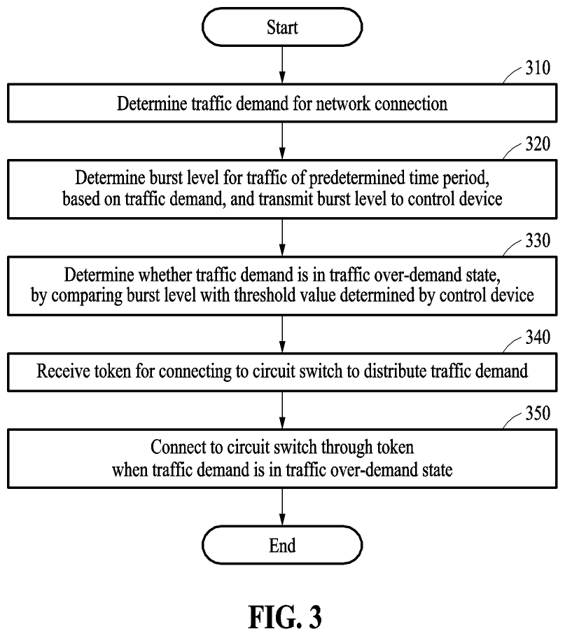

FIG. 3 is a schematic flowchart of an electronic device for distributed scheduling of a network, according to an embodiment.

In the following embodiments, operations may be performed sequentially but not necessarily. For example, the order of the operations may change and at least two of the operations may be performed in parallel. Operations 310 to 350 may be performed by at least one component (e.g., a processor) of an electronic device.

In operation 310, an electronic device may determine a traffic demand for a network connection. The electronic device may determine the traffic demand using CMS.

In operation 320, the electronic device may determine a burst level for traffic of a predetermined time period, based on the traffic demand, and may transmit the burst level to a control device.

In operation 330, the electronic device may determine whether the traffic demand is in a traffic over-demand state, by comparing the burst level with a threshold value determined by the control device.

In operation 340, the electronic device may receive a token for connecting to a circuit switch to distribute the traffic demand.

In operation 350, the electronic device may connect to the circuit switch through the token when the traffic demand is in the traffic over-demand state. The electronic device may determine a time to connect to the circuit switch, based on the burst level, and may connect to the circuit switch during the time.

When the traffic demand is not in the traffic over-demand state or when the connection of the circuit switch is terminated, the electronic device may transmit the token to a next electronic device in a predetermined order.

The threshold value may be determined based on a burst level of each electronic device connected to the control device. The threshold value may be determined as one burst level among the burst levels of electronic devices connected to the control device. The token may be transmitted in a predetermined order between electronic devices connected to the control device.

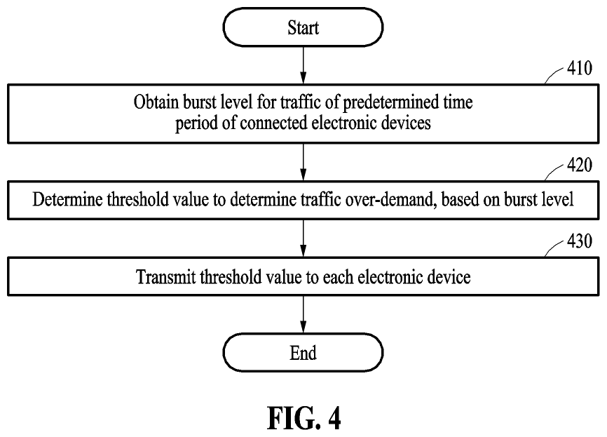

FIG. 4 is a schematic flowchart of a control device for distributed scheduling of a network, according to an embodiment.

In the following embodiments, operations may be performed sequentially but not necessarily. For example, the order of the operations may change and at least two of the operations may be performed in parallel. Operations 410 to 430 may be performed by at least one component (e.g., a processor) of an electronic device.

In operation 410, a control device may obtain a burst level for traffic of a predetermined time period of connected electronic devices.

In operation 420, the control device may determine a threshold value to determine a traffic over-demand, based on the burst level. The control device may determine one burst level among burst levels of the connected electronic devices as the threshold value.

In operation 430, the control device may transmit the threshold value to each electronic device.

The electronic device may determine whether a traffic demand of the electronic device is in a traffic over-demand state, by comparing the burst level with the threshold value.

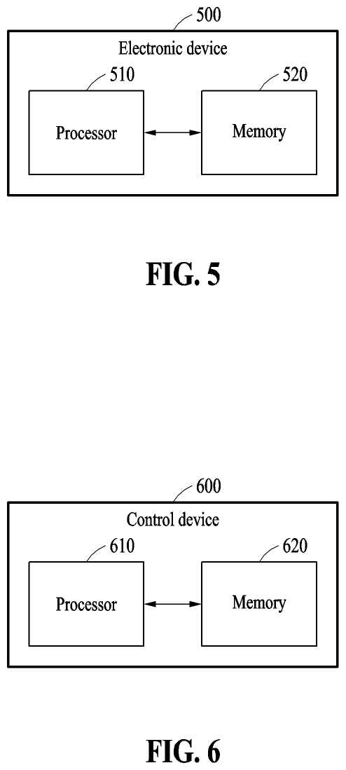

FIG. 5 is a schematic block diagram of an electronic device for distributed scheduling of a network, according to an embodiment.

Referring to FIG. 5, an electronic device 500 may include a processor 510. The processor 510 may include at least one processor. The electronic device 500 may further include a memory 520.

The memory 520 may store instructions (or programs) executable by the processor 510. For example, the instructions may include instructions for executing an operation of the processor 510 and/or an operation of each component of the processor 510.

The processor 510 may be a device that executes instructions or programs or controls the electronic device 500 and may include, for example, various processors such as a central processing unit (CPU) and a graphics processing unit (GPU). The processor 510 may determine a traffic demand for a network connection. The processor 510 may determine a burst level for traffic of a predetermined time period, based on the traffic demand, and may transmit the burst level to a control device. The processor 510 may determine whether the traffic demand is in a traffic over-demand state, by comparing the burst level with a threshold value determined by the control device. The processor 510 may receive a token for connecting to a circuit switch to distribute the traffic demand. The processor 510 may connect to the circuit switch through the token when the traffic demand is in the traffic over-demand state.

When the traffic demand is not in the traffic over-demand state or when the connection of the circuit switch is terminated, the processor 510 may transmit the token to a next electronic device in a predetermined order. The processor 510 may determine a time to connect to the circuit switch, based on the burst level, and may connect to the circuit switch during the time.

The processor 510 may determine the traffic demand using CMS.

The threshold value may be determined based on a burst level of each electronic device connected to the control device. The threshold value may be determined as one burst level among the burst levels of electronic devices connected to the control device. The token may be transmitted in a predetermined order between electronic devices connected to the control device.

In addition, the electronic device 500 may process the operations described above. FIG. 6 is a schematic block diagram of a control device for distributed scheduling of a network, according to an embodiment.

Referring to FIG. 6, a control device 600 may include a processor 610. The processor 610 may include at least one processor. The control device 600 may further include a memory 620.

The memory 620 may store instructions (e.g., programs) executable by the processor 610. For example, the instructions may include instructions for performing an operation of the processor 610 and/or an operation of each component of the processor 610.

The processor 610 may be a device that executes instructions or programs or controls the control device 600 and may include, for example, various processors such as a CPU and a GPU. The processor 610 may obtain a burst level for traffic of a predetermined time period of connected electronic devices. The processor 610 may determine a threshold value to determine a traffic over-demand, based on the burst level. The processor 610 may transmit the threshold value to each electronic device.

The processor 610 may determine one burst level among burst levels of the connected electronic devices as the threshold value.

The electronic device may determine whether a traffic demand of the electronic device is in a traffic over-demand state, by comparing the burst level with the threshold value.

In addition, the control device 600 may process the operations described above.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specifically designed and constructed for the purposes of examples, or they may be of the kind well known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. An electronic device comprising:
a processor; and
a memory configured to store instructions,
wherein the instructions, when executed by the processor, cause the electronic device to:
determine a traffic demand for a network connection;
based on the traffic demand, determine a burst level for traffic of a predetermined time period and transmit the burst level to a control device;
by comparing the burst level with a threshold value determined by the control device, determine whether the traffic demand is in a traffic over-demand state;
receive a token for connecting to a circuit switch to distribute the traffic demand; and
when the traffic demand is in the traffic over-demand state, connect to the circuit switch through the token.

2. The electronic device of claim 1, wherein
the instructions, when executed by the processor, cause the electronic device to, when the traffic demand is not in the traffic over-demand state or when the connection of the circuit switch is terminated, transmit the token to a next electronic device in a predetermined order.

3. The electronic device of claim 1, wherein
the instructions, when executed by the processor, cause the electronic device to:
determine a time to connect to the circuit switch, based on the burst level; and
connect to the circuit switch during the time.

4. The electronic device of claim 1, wherein
the threshold value is determined based on a burst level of each electronic device connected to the control device.

5. The electronic device of claim 1, wherein
the threshold value is determined as one burst level among burst levels of electronic devices connected to the control device.

6. The electronic device of claim 1, wherein
the token is transmitted in a predetermined order between electronic devices connected to the control device.

7. The electronic device of claim 1, wherein
the instructions, when executed by the processor, cause the electronic device to determine the traffic demand using count-min sketch (CMS).

8. The electronic device of claim 1, being a switch used in top of rack (ToR).

9. A control device comprising:
a processor; and
a memory configured to store instructions,
wherein the instructions, when executed by the processor, cause the control device to:
obtain a burst level for traffic of a predetermined time period of connected electronic devices;
based on the burst level, determine a threshold value to determine a traffic over-demand; and
transmit the threshold value to each electronic device.

10. The control device of claim 9, wherein
the electronic device is configured to, by comparing the burst level with the threshold value, determine whether a traffic demand of the electronic device is in a traffic over-demand state.

11. The control device of claim 9, wherein
the instructions, when executed by the processor, cause the electronic device to determine one burst level among burst levels of the connected electronic devices as the threshold value.

12. A method of operating an electronic device, the method comprising:
determining a traffic demand for a network connection;
based on the traffic demand, determining a burst level for traffic of a predetermined time period and transmitting the burst level to a control device;
by comparing the burst level with a threshold value determined by the control device, determining whether the traffic demand is in a traffic over-demand state;
receiving a token for connecting to a circuit switch to distribute the traffic demand; and
when the traffic demand is in the traffic over-demand state, connecting to the circuit switch through the token.

13. The method of claim 12, further comprising:
when the traffic demand is not in the traffic over-demand state or when the connection of the circuit switch is terminated, transmitting the token to a next electronic device in a predetermined order.

14. The method of claim 12, wherein
the connecting to the circuit switch comprises:
determining a time to connect to the circuit switch, based on the burst level; and
connecting to the circuit switch during the time.

15. The method of claim 12, wherein
the threshold value is determined based on a burst level of each electronic device connected to the control device.

16. The method of claim 12, wherein
the threshold value is determined as one burst level among burst levels of electronic devices connected to the control device.

17. The method of claim 12, wherein
the token is transmitted in a predetermined order between electronic devices connected to the control device.

18. The method of claim 12, wherein
the determining of the traffic demand comprises determining the traffic demand using count-min sketch (CMS).
